(19) United States
(12) Patent Application Publication
(10) Pub. No.: US 2007/0086815 A1
(43) Pub. Date: Apr. 19, 2007

(54) Cleaning device and image printing apparatus installing the cleaning device

(75) Inventors: Junichi Koiso, Tokyo (JP); Erika Sawada, Tokyo (JP); Hideaki Tanaka, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/473,037

(22) Filed: Jun. 23, 2006

(30) Foreign Application Priority Data
Oct. 14, 2005 (JP) 2005-299952

(51) Int. Cl. G03G 21/00

(52) U.S. Cl. 399/350

(57) ABSTRACT

The present invention provides a cleaning device which has an elastic cleaning blade coming into pressure-contact with a surface of an image carrier at a edge on one surface side thereof in a counter state to remove toner remaining on the image carrier, comprises a regulating member being arranged so as to oppose to the other side surface of the cleaning blade, wherein the regulating member has a regulating surface for regulates a flex amount of the cleaning blade, the regulating surface being faced oppositely to the other side surface of the cleaning blade at a predetermined gap.

This application makes reference to, incorporates the same herein, and claims all benefits accruing under 35U.S.C. § 119 from an application for CLEANING DEVICE AND IMAGE PRINTING APPARATUS earlier filed in the Japanese Patent Office on Oct. 14, 2005, and there duly assigned the application No. 2005-299952.

### BACKGROUND OF THE INVENTION

1. Field of the Invention

The present invention relates to an image printing apparatus such as a copying machine, a printer, a facsimile machine, a multifunctional peripheral having these plurality of functions, and the like and, more particularly, to a cleaning device which cleans residual toner on an image carrier by a cleaning blade.

2. Description of Related Art

In general, in an image printing apparatus employing the electrophotographic process or the like, an electrostatic latent image corresponding to a document image is formed on the surface of an image carrier, e.g., a photosensitive drum, charged to a predetermined potential, and a visible image (toner image) is formed by a developing device. The toner image formed on the image carrier reaches an image transfer portion by rotation of the image carrier, and is transferred onto an image transfer medium such as an image printing sheet conveyed to the image transfer portion. After the toner image is transferred onto the image transfer medium, the residual toner on the image carrier is removed by a cleaning device arranged at a predetermined position around the image carrier.

A cleaning blade disposed in the cleaning device has one end fixed to a blade support member, and its other end forms a free end projecting from the blade support member. A pressure-contact ridgeline portion at the edge on one side of the free end is brought into pressure-contact with the image carrier.

In the image printing apparatus in which the cleaning blade is in pressure-contact with the image carrier in a counter state so as to scrape off the toner remaining on the surface of the rotating image carrier, friction of the image carrier and cleaning blade deforms the free end of the cleaning blade to elastically flex the edge of the cleaning blade.

In the cleaning device of Japanese Unexamined Patent Publication No. 5-289580 (patent reference 1), a backing member is disposed to about against the rear surface side of an image carrier at an abutting position with a cleaning blade. The backing member supports the cleaning blade to supply a strong abutting force required for cleaning to the cleaning blade.

The cleaning device of Japanese Unexamined Patent Publication No. 5-46057 (patent reference 2) has a cleaning blade which is disposed to project from a holder that supports the cleaning blade so the cleaning blade can be flexed by a pressure-contact force against the surface of an image carrier. A flexible portion length changeable mechanism is provided which can change the length of the edge of the cleaning blade.

In the cleaning device of Japanese Unexamined Patent Publication No. 6-308870 (patent reference 3), a cleaning blade is brought into pressure-contact with a photosensitive drum with an elastic force. A seal member is provided which shields gaps between portions near the respective side ends of the cleaning blade, a support plate, and a shield sheet and the recovery port of residual toner.

The cleaning device of Japanese Unexamined Patent Publication No. 6-186887 (patent reference 4) has a cleaning blade which comes into contact with an image carrier, and a support member which supports the cleaning blade by clamping it. The support member is formed of a member having a higher frictional coefficient than that of the cleaning blade, so it can suppress slide of the cleaning blade.

In the cleaning device of Japanese Unexamined Patent Publication No. 2-150885 (patent reference 5), a cleaning blade is fixed to a holding member made of a metal. The rear surface of the holding member is elastically biased by a leaf spring to bring the edge of the cleaning blade into pressure-contact with the surface of a photosensitive drum.

In order to prevent the cleaning blade disposed in a counter state from flexing excessively, conventionally, toner is forcedly supplied as lubricant to the cleaning blade prior to a printing operation, or one of other lubricants is supplied to the cleaning blade. When the temperature of the cleaning blade increases, the contact frictional resistance of the cleaning blade increases due to a change in rubber characteristics. Then, the torque of the image carrier increases to increase the flex of the cleaning blade.

In recent years, the particle size of the toner tends to decrease for achieving a high image quality. If a rubber material having high resilience is used to cope with this tendency so the cleaning performance in a particularly low-temperature, low-humidity environment is improved, flex tends to occur in a high-temperature, high-humidity environment. Therefore, a fan or duct is often arranged at an appropriate portion in the image printing apparatus to minimize the temperature increase of the cleaning blade, so the inconveniences described above are avoided.

With these countermeasures, the cleaning blade deforms at a low probability. As image printing continues, however, an inconvenience may occur unexpectedly. This is partly because the frictional force of the cleaning blade in the main scanning direction becomes non-equilibrium. When the frictional force becomes non-equilibrium, a twist occurs in the main scanning direction of the cleaning blade, and an abutting angle or the like with respect to the image carrier undesirably changes in the main scanning direction. In particular, if the frictional force at each end of the cleaning blade in the main scanning direction becomes non-equilibrium, the twist becomes maximum, and deformation is likely to occur from an end side where the frictional force is large. Factors that cause the frictional force non-equilibrium include nonuniform machining accuracy (length, angle, or the like) of the cleaning blade in the main scanning direction, non-equilibrium of the frictional resistance in the main scanning direction, and the like.

These factors consequently lead to the following requirements. For example, a high machining accuracy may be required for the cleaning blade. The printing rate in the main scanning direction may be stored in a large-capacity memory, and the toner supply amount (a band-like toner image or the like) to the cleaning blade in the main scanning direction may be changed accordingly. A duct may be disposed in the cleaning device in a complicated manner to suppress the temperature increase. These countermeasures lead to inconveniences such as a decrease in degrees of freedom in layout in the cleaning device.

In particular, in a low-temperature, low-humidity environment, the flex of the cleaning blade increases to degrade the cleaning performance.

In any one of the cleaning devices described in patent references 1 to 5 is a cleaning device, the cleaning blade abuts against the image carrier in the counter state. However, reliable countermeasures are not taken to prevent wear and deformation of the edge of the blade which are caused by excessive flex of the cleaning blade, and to prevent the toner from passing through between the cleaning blade and image carrier.

When the entire rear surface of the cleaning blade formed of an elastic member is adhered to the support member made of a metal or the like, the difference in thermal expansion between the cleaning blade and support member deforms the cleaning blade. Then, the ridgeline accuracy (the pressure-contact accuracy of the cleaning blade with respect to the image carrier) at the edge of the cleaning blade degrades.

Furthermore, when the edge of the cleaning blade is regulated by the support member in pressure-contact with it, the environmental temperature and humidity of the cleaning blade change to impair the physical properties of the cleaning blade such as the rubber hardness and elasticity to degrade the durability.

### SUMMARY OF THE INVENTION

The present invention has been made in view of the above circumstances in the related arts and can provide a cleaning device in which the flex of a cleaning blade in slidable contact with an image carrier is regulated to a predetermined amount or less so as not to impair any more the elasticity of the cleaning blade the restoration force of which has been decreased by long-term flex, to prevent wear and deformation of the edge of the cleaning blade, so that reliable, uniform cleaning can be performed, and an image printing apparatus installing such a cleaning device.

The cleaning device and image printing apparatus of the present invention have the following aspect.

A cleaning device having a cleaning blade formed of an elastic body, said cleaning blade being brought into contact at a pressure-contact ridgeline portion located at a edge of one surface side of said cleaning blade with a surface of an image carrier in a counter state, so as to oppose a rotational direction of said image carrier, to remove toner remaining on the surface of said image carrier, comprising

a regulating member being arranged so as to oppose to the other side surface of said cleaning blade,

wherein said regulating member has a regulating surface for regulates a flex amount of the cleaning blade, the regulating surface being faced oppositely to the other side surface of the cleaning blade at a predetermined gap.

The present invention is more specifically described in the following paragraphs by reference to the drawings attached only by way of example.

### BRIEF DESCRIPTION OF THE DRAWINGS

A more complete appreciation of the present invention, and many other attendant features and advantages thereof, will become readily apparent as the same becomes better understood by reference to the following detailed description when considered in conjunction with the accompanying drawings in which like reference symbols and reference numerals indicate the same or similar components, wherein:

FIG. 1 shows the overall schematic view of an arrangement of an image printing apparatus according to an embodiment of the present invention which comprises an image printing apparatus main body, image reading device, and automatic document feeder;

FIGS. 2A and 2B are sectional views respectively showing cleaning devices of the present invention;

FIG. 3 is a partial perspective view showing the positional relationship between a cleaning device and an image carrier in the cleaning device of the present invention;

FIGS. 4A and 4B are graphs each showing the test result of the flex amount of a cleaning blade in an environment where low temperature, low humidity and high temperature, high humidity are repeated;

FIGS. 5A to 5C are partial schematic views showing the operational relationship between the image carrier and the cleaning device of the present invention which includes the cleaning blade and a regulating member;

FIGS. 6A and 6B are partial schematic views showing the operational relationship between the image carrier and a conventional cleaning device; and

FIG. 7 shows the overall schematic view of an arrangement of a color image printing apparatus according to another embodiment of the present invention.

### DETAILED DESCRIPTION OF THE PREFERRED EMBODIMENTS

Several preferred embodiments of the present invention will be described with reference to the accompanying drawings. Note that the following description does not limit the technical scope of the claims or the meanings of the technical terms.

[Image Printing Apparatus]

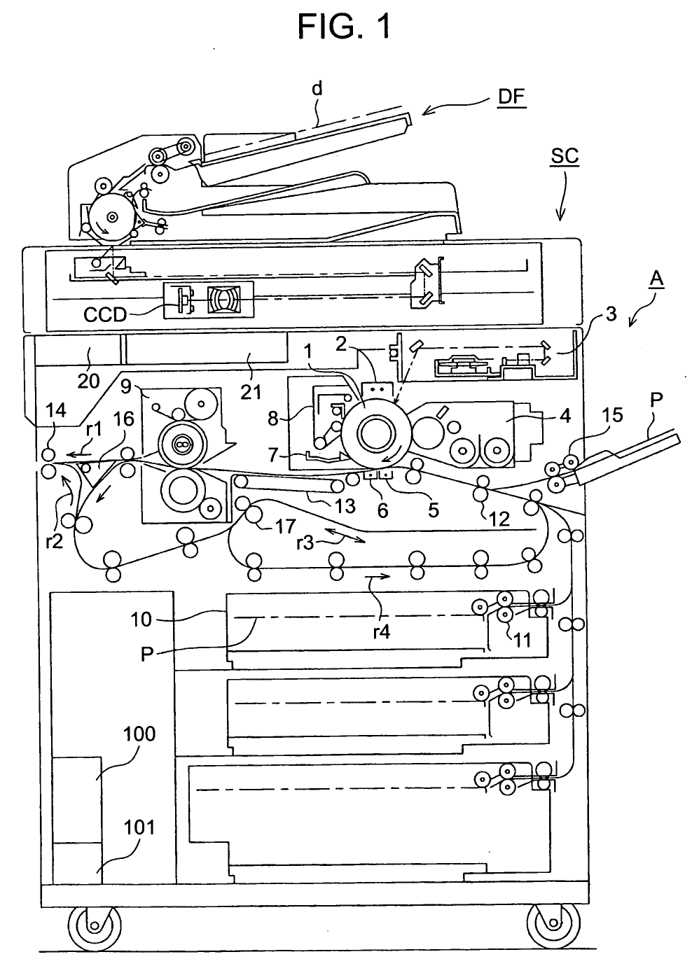

FIG. 1 shows the overall schematic arrangement of an image printing apparatus according to an embodiment of the present invention which comprises an image printing apparatus main body A, image reading device SC, and automatic document feeder DF.

The image printing apparatus main body A shown in FIG. 1 comprises an image printing portion including an image carrier 1, charging unit 2, image exposing device 3, developing device 4, transfer unit 5, discharging unit 6, separation pawl 7, cleaning device 8, and the like, a fixing device 9, and an image transfer medium convey system.

The image transfer medium convey system comprises the first convey portion including a feed cassette 10, first feed mechanism 11, second feed mechanism 12, convey mechanism 13, delivery mechanism 14, and manual feed mechanism 15, and a circulating refeed portion which refeeds an image transfer medium P by circulation.

The feed cassette 10 and first feed mechanism 11 include a plurality of (three stages shown in FIG. 1) feed mechanisms, and accommodate and feed image transfer media P of a plurality of sizes. The size of the image transfer medium is input by manual setting at an operating portion 21 or by automatic image transfer medium size setting which is done by an image transfer medium size detection unit.

An image transfer medium P which passes through the convey mechanism 13 and is fixed by the fixing device 9 is selectively conveyed by a convey route switching unit 16 to either one of a convey route r1 as a straight delivery path, a convey route r2 as a reversal delivery path, and a convey route r3 as a double-sided circulating path.

An image transfer medium P passing through the convey route r1 is delivered with its image printing surface facing up. An image transfer medium P passing through the convey route r2 advances to the convey route r3 and a convey route r4 of the double-sided circulating path, is reversely conveyed, passes through the convey route r2, and is delivered with its image printing surface facing down.

In the second convey portion, the image transfer medium P printed by the image printing portion is branched before the delivery mechanism 14 by the convey route switching unit 16 and conveyed along a circulating refeed route. The image transfer medium P is then reversed by a reversal convey rollers 17 midway along the circulating refeed route and refed to the image printing portion through the second feed mechanism 12.

A document d placed on the document table of the automatic document feeder DF is conveyed by a feed mechanism. The image or images on one or two sides of the document d are scanned by the optical system of the image reading device SC and read by an image sensor CCD. An analog signal obtained by photoelectrical conversion of the image sensor CCD is subjected to an analog process, A/D conversion, shading correction, an image compression process, and the like by an image processor 20. An obtained image signal is supplied to the image exposing device 3.

In the image printing portion, processes such as charging, exposure, development, transfer, separation, cleaning, and the like are performed.

An image is transferred onto the image transfer medium P, fed from the feed cassette 10 or manual feed mechanism 15, by the transfer unit 5. The image transfer medium P which carries the image is fixed by the fixing device 9 and delivered from the delivery mechanism 14.

[Cleaning Device]

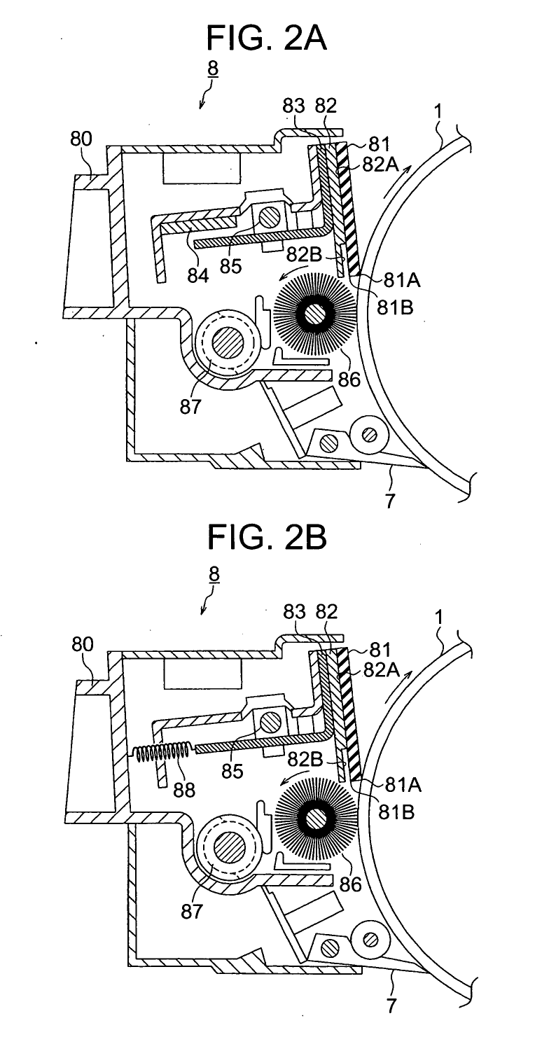

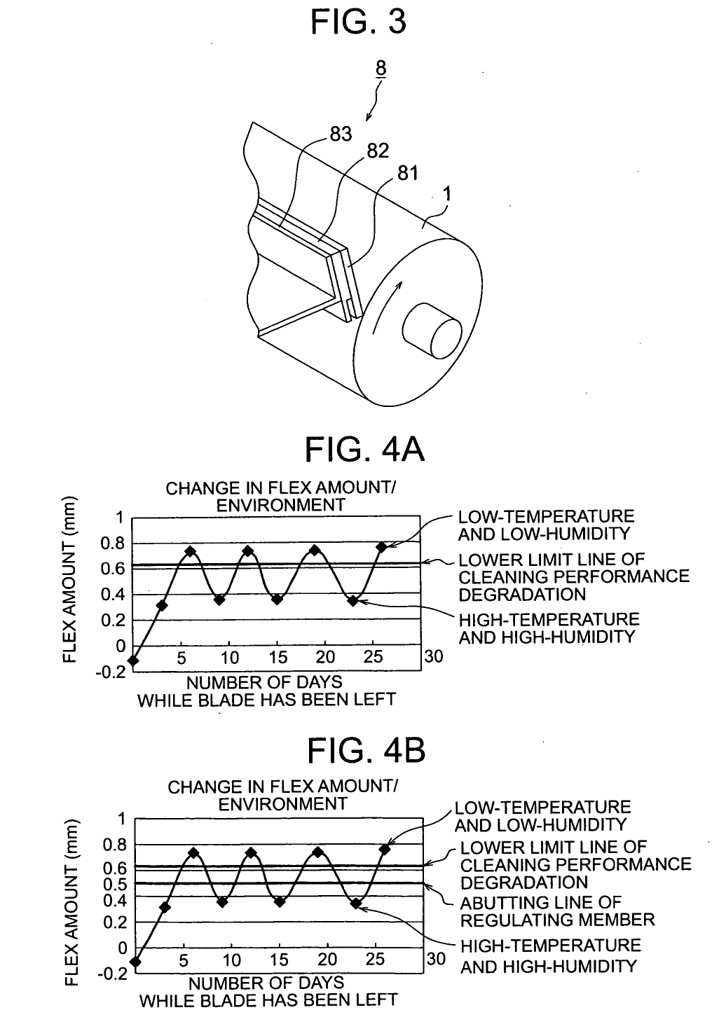

The cleaning device according to the present invention will be described with reference to FIGS. 2A, 2B, and 3.

Each of FIGS. 2A and 2B is a sectional view showing a cleaning device of the present invention, and FIG. 3 is a partial perspective view showing the positional relationship between the cleaning device 8 and the image carrier 1 in the cleaning device 8 of the present invention.

Referring to FIGS. 2A, 2B, and 3, a cleaning blade (to be merely referred to as a blade hereinafter) 81 is made of an elastic material. After the image is transferred to the image transfer medium, the toner remaining on the image carrier 1 is scraped from the image carrier 1 by the blade 81. A pressure-contact ridgeline portion 81A at the edge of the blade 81 is brought into pressure-contact with the outer surface of the rotating image carrier 1 in a counter state upstream of a vertically upper position where is in the counter-gravity direction from the rotation center of the image carrier 1.

The blade 81 is made of appropriately elastic polyurethane rubber, silicone rubber, or the like.

The blade 81 of the cleaning device 8 according to the present invention is fixed to a blade support member 83 through a regulating member 82. The regulating member 82 is fixed to a blade support member 83 which holds the cleaning blade 81. As shown in FIG. 2A, the blade 81 is pressurized toward the image carrier 1 by a weight 84 held at the other end of the blade support member 83, and is accordingly brought into pressure-contact with the image carrier 1. Alternatively, as shown in FIG. 2B, the other end of the blade support member 83 is biased toward the image carrier 1 by a repelling coiled spring 88. As a result, the one-side ridgeline portion (pressure-contact ridgeline portion) 81A located at the edge of the blade 81 is brought into pressure-contact with the image carrier 1.

A blade assembly unit 80 comprising the blade 81, regulating member 82, blade support member 83, and weight 84 or coil spring 88 pivots about a shaft body 85 as a center, so the blade 81 is brought into pressure-contact with the image carrier 1.

The residual toner on the image carrier 1 which is scraped by the blade 81 is collected by the counterclockwise rotation (see the arrow in FIGS. 2A and 2B) of a brush-like guide roller 86 arranged below the blade 81 and conveyed toward a toner convey screw 87.

The guide roller 86 and spiral toner convey screw 87 are rotatably supported at predetermined positions of the housing 80 and rotated by a driving mechanism (not shown).

The residual toner conveyed by the toner convey screw 87 is conveyed to the developing device 4 through a toner recycle device (not shown) or to a waste toner box (not shown) and recovered.

[Specifications of Cleaning Device]

The cleaning device employs the counter scheme. As the material of the blade 81, urethane rubber (having rubber hardness of 70° (JIS A hardness), Young's modulus of 65 km/cm², and impact resilience of 68% at room temperature of 25° C.) is used. The abutting angle with the image carrier 1 is 20°. The bite amount of the blade 81 into the image carrier 1 is 1 mm. The blade 81 has a thickness of 2 mm and a length of 340 mm in the main scanning direction. Note that “JIS A hardness” is a value measured by a spring type A hardness tester in accordance with JIS K 7312.

[Flex Amount of Cleaning Blade and Environmental Test]

FIGS. 4A and 4B are graphs each showing the test result of the flex amount of the cleaning blade in an environment where low temperature, low humidity and high temperature, high humidity are repeated.

The pressure-contact force of the blade 81 with respect to the image carrier 1 was set to 18.30 N/m (N stands for Newton). The low-temperature, low-humidity environment conditions included a temperature of 10° C. and a humidity of 20% RH. The high-temperature, high-humidity environment conditions included a temperature of 30° C. and a humidity of 80% RH. The number of days while the blade 81 has been left and the flex amount of the blade 81 were measured. The flex amount is given by the distance from a reference surface (rear surface) 82A of the blade 81 through which the blade 81 is attached to the regulating member 82 to the other-side ridgeline portion (rear surface ridgeline portion) 81B at the most edge of the blade 81.

FIG. 4A shows the flex amount of a blade 81 with no regulating member 82.

The flex amount of the blade 81 in the low-temperature, low-humidity environment is about 0.7 mm, indicating large elastic deformation. The flex amount of the blade 81 in the high-temperature, high-humidity environment is about 0.3 mm, indicating small elastic deformation.

When excessive flex or vibration occurs in the blade 81, the blade 81 leaves some residual toner unscraped. The flex amount as the lower limit line of the cleaning performance degradation at which the residual toner on the image carrier 1 passes through the abutting position of the blade 81 and image carrier 1 is set to 0.6 mm. Hence, from the test results of the flex amounts shown in FIGS. 4A and 4B, the flex amount of the blade 81 must be regulated in the low-temperature, low-humidity environment.

[Flex of Cleaning Blade and Regulating Member]

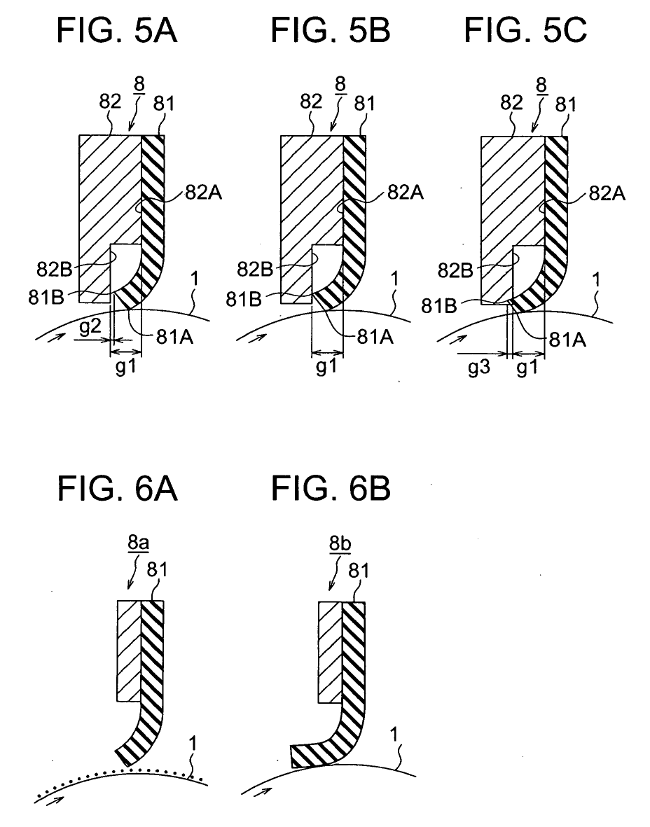

FIGS. 5A to 5C are partial schematic views showing the operational relationship between the image carrier 1 and the cleaning device 8 of the present invention which includes the cleaning blade 81 and regulating member 82.

The regulating member 82 has a regulating surface 82B which faces oppositely at a predetermined gap to a side surface of the cleaning blade 81 formed on a side opposing the reference surface 82A of the cleaning blade 81. The regulating surface 82B can regulates a deformation (flex) amount of the edge of the cleaning blade 81. More specifically, a gap g1 between the reference surface 82A of the blade 81 and the regulating surface 82B of the regulating member 82 is set to 0.5 mm.

FIG. 5A shows a normal state wherein the edge of the blade 81 flexes to form a gap g2 between the rear surface ridgeline portion 81B and the regulating surface 82B of the regulating member 82. In this state, the flex amount is less than 0.5. A good cleaning performance can be obtained even in a low-temperature, low-humidity environment (see FIG. 4B).

FIG. 5B shows a state wherein the edge of the blade 81 further flexes and the rear surface ridgeline portion 81B abuts against the regulating surface 82B of the regulating member 82. The regulating member 82 is made of a rigid material. In this case, the flex amount of the blade 81 is equal to the gap g1 and, e.g., 0.5 mm. Yet, as the flex amount is 0.5 mm or less, a good cleaning performance can be obtained even in a low-temperature, low-humidity environment (see FIG. 4B).

FIG. 5C shows a state wherein the edge of the blade 81 flexes further largely so the flex amount of the edge of the blade 81 reaches 0.5 mm or more. The rear surface ridgeline portion 81B at the edge of the blade 81 bites into the regulating surface 82B of the regulating member 82. The edge of the blade 81 elastically deforms to form a bite amount g3. In this case, at the lower limit of the cleaning performance degradation, the bite amount g3 is 0.1 mm and the flex amount of the blade 81 is 0.6 mm, although depending on the elasticity of the blade 81 or the bite amount g3 of the image carrier 1 (see FIG. 4B). The rear surface ridgeline portion 81B of the blade 81 abuts against the regulating surface 82B of the regulating member 82 to regulate the flex amount not to exceed 0.6 mm. Hence, the residual toner is prevented from passing through (being left unscraped by the blade 81). In particular, in the low-temperature, low-humidity environment where the flex amount of the blade 81 is large, flex regulation of the regulating member 82 prevents the toner from passing through.

Accordingly when the cleaning blade is arranged on the image carrier, there is provided a predetermined gap between the rear surface ridgeline portion of the cleaning blade and the regulating surface of the regulating member, and when the edge of the cleaning blade flexes over a predetermined gap (largest flex), the rear surface ridgeline portion on a rear surface side of the pressure-contact ridgeline portion of the cleaning blade contacts against the regulating surface to regulate the flex amount.

FIG. 6A is a partial schematic view showing the operational relationship between the image carrier and one conventional cleaning device 8a with no regulating member 82. Since a blade 81 has no regulating member 82, when the flex amount increases in the low-temperature, low-humidity environment, flex of the blade 81 allows the toner to pass through.

FIG. 6B is a partial schematic view showing the operational relationship between the image carrier and another conventional cleaning device 8b with no regulating member 82. Since a blade 81 has no regulating member 82, when the flex amount increases in the low-temperature, low-humidity environment, the side edge surface near the edge of the blade 81 comes into slidable contact with the surface of an image carrier 1. This leaves toner unscraped on the surface of the image carrier 1 to cause a cleaning error.

[Color Image Printing Apparatus]

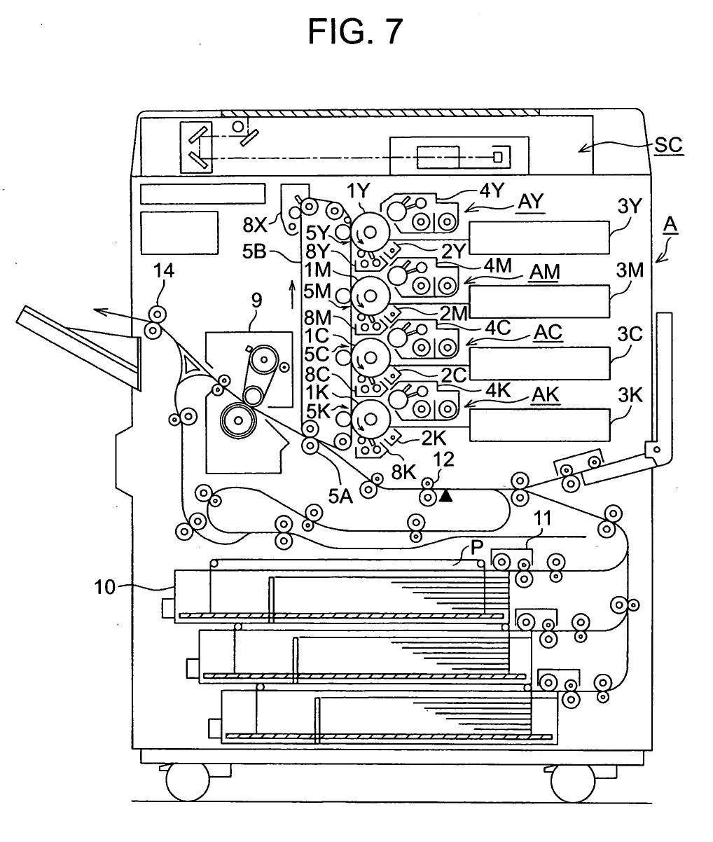

FIG. 7 shows the overall schematic arrangement of a color image printing apparatus according to another embodiment of the present invention. In FIG. 7, the same portions as those having the same functions as in FIG. 1 are denoted by the same reference numerals. Only the respects that are different from their equivalents in FIG. 1 will be described.

An image printing apparatus main body A is called a tandem type color image printing apparatus and comprises a plurality of sets of image printing units AY, AM, AC, and AK, a plurality of image transfer medium feed/convey mechanisms 11 and 12, and a fixing device 9.

The image printing unit AY which forms a yellow (Y) image has a charging unit 2Y, image exposing device 3Y, developing device 4Y, and cleaning device 8Y arranged around a photosensitve drum (first image carrier) 1Y. The image printing unit AM which forms a magenta (M) image has a photosensitve drum (first image carrier) 1M, charging unit 2M, image exposing device 3M, developing device 4M, and cleaning device 8M. The image printing unit AC which forms a cyan (C) image has a photosensitve drum (first image carrier) 1C, charging unit 2C, image exposing device 3C, developing device 4C, and cleaning device 8C. The image printing unit AK which forms a back (K) image has a photosensitve drum (first image carrier) 1K, charging unit 2K, image exposing device 3K, developing device 4K, and cleaning device 8K.

The charging unit 2Y and image exposing device 3Y, the charging unit 2M and image exposing device 3M, the charging unit 2C and image exposing device 3C, and the charging unit 2K and image exposing device 3K form latent image printing units, respectively.

Each of the developing devices 4Y, 4M, 4C, and 4K accommodates a two-component developing agent made of a carrier and a corresponding one of small-particle yellow (Y), magenta (M), cyan (C), and black (K) toners.

An intermediate transfer body 5B (second image carrier), to which images of respective colors are to be transferred from the plurality of photosensitve drums 1Y to 1K of the respective colors, is wound around a plurality of rollers and supported pivotally.

The images of the respective colors formed by the image printing units AY, AM, AC, and AK are sequentially transferred onto the pivoting intermediate transfer body 5B by primary transfer units 5Y, 5M, 5C, and 5K to form a composite color image.

An image transfer medium P accommodated in a feed cassette 10 of the image transfer medium feed/convey mechanism is fed by the first feed mechanism 11 and conveyed to a secondary transfer unit 5A through the second feed mechanism 12 so the color image is transferred onto the image transfer medium P. The image transfer medium P onto which the color image is transferred is clamped in the fixing device 9 to apply heat and pressure to it. Thus, the toner image on the image transfer medium P is fixed. The image transfer medium P is then clamped by a delivery mechanism 14 and delivered outside the image printing apparatus.

After the color image is transferred onto the image transfer medium P by the secondary transfer unit 5A, the image transfer medium P is separated from the intermediate transfer body (second image carrier) 5B in accordance with its curvature. Then, the residual toner on the intermediate transfer body 5B is removed by a cleaning device 8X.

Each of the cleaning devices 8Y, 8M, 8C, and 8K of the process after the primary transfer is provided with a regulating member which regulates the flex amount of the edge of the blade, in the same manner as the cleaning device 8 of the first embodiment described above. This regulating member has a regulating surface so as to maintain a predetermined gap (0.5 mm) from the rear surface of the blade, in the same manner as the cleaning device 8 of the first embodiment described above. The residual toner caused by the excessive flex of the blade is prevented from passing through.

As is apparent from the above description, according to the present invention, the flex of the blade 81 in the low-temperature, low-humidity environment can be regulated by the regulating member 82. Thus, the durability of the blade 81 improves to prolong the timing to exchange the blade 81.

The regulating member is arranged in the cleaning device 8X of the process after the secondary transfer. Thus, the toner is prevented from passing through and the durability of the blade 81 improves, in the same manner as in the process after the primary transfer.

Also, an image printing apparatus which stably prints a high-quality, high-reliability image can be provided.

What is claimed is:

1. A cleaning device having a cleaning blade formed of an elastic body, said cleaning blade being brought into contact at a pressure-contact ridgeline portion located at a edge of one surface side of said cleaning blade with a surface of an image carrier in a counter state, so as to oppose a rotational direction of said image carrier, to remove toner remaining on the surface of said image carrier, comprising
a regulating member being arranged so as to oppose to the other side surface of said cleaning blade,
wherein said regulating member has a regulating surface for regulates a flex amount of the cleaning blade, the regulating surface being faced oppositely to the other side surface of the cleaning blade at a predetermined gap.

2. A cleaning device of claim 1, wherein when said cleaning blade is arranged on said image carrier, there is provided a predetermined gap between said regulating surface and a rear surface ridgeline portion located at an edge of the other side surface of said cleaning blade, and when said cleaning blade flexes predetermined flex amount, said rear surface ridgeline portion contacts against said regulating surface to regulate the flex amount.

3. A cleaning device of claim 1, wherein said regulating member is fixed to a blade support member which holds said cleaning blade.

4. A cleaning device of claim 1, wherein said regulating member is made of a rigid material.

5. A cleaning device of claim 1, wherein said image carrier comprises a photosensitive drum which carries an electrostatic latent image.

6. A cleaning device of claim 5, wherein said image carrier comprises an intermediate transfer body on which a toner image formed on said photosensitive drum is transferred.

7. A cleaning device of claim 1, further comprising a weight to bias said cleaning blade toward said image carrier.

8. A cleaning device of claim 1, further comprising a repelling coiled spring to bias said cleaning blade toward said image carrier.

9. An image printing apparatus comprising the cleaning device of claim 1.
